(19) United States
(12) Patent Application Publication
(10) Pub. No.: US 2009/0108488 A1
(43) Pub. Date: Apr. 30, 2009

(54) Process for Production of Hybrid Polymeric Material

(76) Inventor: Kazuaki Matsumoto, Osaka (JP)

Correspondence Address: BIRCH STEWART KOLASCH & BIRCH, PO BOX 747, FALLS CHURCH, VA, 22040-0747, US

(21) Appl. No.: 11/988,311

(22) PCT Filed: Aug. 3, 2006
(86) PCT No.: PCT/JP2006/315368

§ 371 Date: Jan. 4, 2008

(30) Foreign Application Priority Data
Aug. 18, 2005 (JP) 2005-237074

(51) Int. Cl. B29C 47/50; C08K 3/10; C08K 3/22; B29C 47/38; C08K 3/34

(52) U.S. Cl. 264/211.23; 524/403; 524/413; 524/430; 524/442; 264/211.21

(57) ABSTRACT

Provided is a process for continuous production of an organic-inorganic hybrid polymeric material in which inorganic substances are finely dispersed in a resin on a nanometer order, on an industrial scale without using any organic solvent or the like by using a simple apparatus. In the process, a thermoplastic resin having an acid number falling within a range from 1 to 200 mgKOH/g is melted and incorporated, to produce a composite composition, with an inorganic component formed from a metal alkoxide compound and/or a partial condensate thereof in the absence of an organic solvent capable of dissolving a thermoplastic resin. It is preferable to melt-knead by using as a production apparatus a continuous kneading apparatus including a twin screw extruder.

### TECHNICAL FIELD

The present invention relates to a process for easily producing a hybrid polymeric material, on an industrial scale, in which a thermoplastic resin is incorporated to form a composite with an inorganic component, even without using any organic solvent capable of dissolving the thermoplastic resin.

### BACKGROUND ART

There have been widely studied organic-inorganic hybrid polymeric materials in which resins are incorporated with inorganic elements such as Si, Ti or Zr for the purpose of improving various physical properties of plastics such as the surface hardness, gloss, staining resistance, strength, heat resistance, weatherability and chemical resistance.

Examples of the process for production of an organic-inorganic hybrid polymeric material include: a process in which an organic monomer or an organic polymer is radically copolymerized with a compound containing an inorganic skeleton such as an alkylsiloxane; a process in which inorganic functional groups such as alkoxysilane groups are bonded as side chains to an organic polymer and thereafter the functional groups are cross-linked; and a process in which an inorganic compound precursor such as an alkoxysilane is dissolved in the presence of an organic polymer having functional groups and thereafter the inorganic compound is synthesized by means of the sol-gel reaction. For example, in Patent Document 1, described is a process in which a vinyl polymer and a silicon compound are reacted with each other and thereafter these are cross-linked with each other by means of the sol-gel method to yield an organic-inorganic hybrid polymeric material.

In Patent Document 2, described is a process in which alkoxysilanes are impregnated into an organic polymer and subjected to a hydrolysis/condensation reaction to synthesize a silicon hybrid material. However, most of these conventional processes for production of organic-inorganic hybrid polymeric materials are those processes which use the sol-gel method and are conducted in solution systems. However, although such processes for production can produce simple structures such as films and rods, it has been extremely difficult to produce molded products having complicated shapes. Processes in solution systems are also disadvantageous from the viewpoint of productivity and cost, and hence are not practical except for special applications.

In Patent Document 3, disclosed is a hybrid polymeric material obtained by melt-kneading, with a kneading machine, an organic polymer and a metal alkoxide compound, the organic polymer having been beforehand subjected to a modification treatment or the like so as to have metal alkoxy groups; however, those organic polymers which are usable in this process are limited to special polymers, and hence this process also involves a problem that the production cost is very high. Further, in Patent Document 4, disclosed is a hybrid polymeric material obtained by melt-kneading with a kneading machine an organic polymer having bonds such as ester bonds/carbonate bonds/amide bonds/urethane bonds and a metal alkoxide compound. However, in this process, the reaction with the alkoxide is based on such reactions as due to a trace amount of water or the like present in the system, and hence some resins suffer from a problem that such water promotes the hydrolysis reaction of the resins (namely, the decomposition reaction of the resins).

Patent Document 1: Japanese Patent Laid-Open No. 5-86188

Patent Document 2: Japanese Patent Laid-Open No. 5-125191

Patent Document 3: WO2002/88255

Patent Document 4: Japanese Patent Laid-Open No. 2002-371186

### DISCLOSURE OF THE INVENTION

### Problems to be Solved by the Invention

The present invention has solved the conventional problems, and an object of the present invention is to provide processes for producing, with high productivity and low cost and in a simple and practical manner, organic-inorganic hybrid polymeric materials suitable for applications to high-performance and high-function plastics, polymeric materials containing as a component thereof such an organic-inorganic hybrid polymeric material, and molded products obtained by processing these polymeric materials.

### Means for Solving the Problems

In view of the above-described problems of conventional techniques, the present inventor has achieved a diligent study, and consequently has perfected the present invention by discovering: by beforehand bonding, to a resin, functional groups to be catalyst for sol-gel reaction, the dealcoholization reaction and the condensation reaction of a metal alkoxide are progressed in the resin with the molten resin as reaction place, without externally adding any solvent, any catalyst and water; moreover, by performing the above-described reactions with a continuous kneading apparatus, a hybrid polymeric material can be continuously produced, leading to extremely easy industrialization and continuous mass production.

Specifically, the present invention includes the following aspects.

A first aspect of the present invention is a process for production of a hybrid polymeric material, the process including producing a composite composition in which a thermoplastic resin having an acid number of 1 to 200 mgKOH/g is incorporated with an inorganic component formed from a metal alkoxide compound and/or a partial condensate thereof by melting the thermoplastic resin.

A second aspect of the present invention is the process for production of a hybrid polymeric material according to the first aspect, the process including producing a composite composition in which a thermoplastic resin having an acid number of 1 to 200 mgKOH/g is incorporated with an inorganic component by bringing the thermoplastic resin in the molten state thereof into contact with the metal alkoxide compound and/or the partial condensate thereof.

A third aspect of the present invention is the process for production of a hybrid polymeric material according to the first or second aspect, wherein the metal component in the metal alkoxide compound and/or the partial condensate thereof includes at least one of Si, Ti, Zr, Al, Ba, Ta, Ge, Ga, Cu, Sc, Bi, Sn, B, Fe, Ce, W, Pb and lanthanoids.

A fourth aspect of the present invention is the process for production of a hybrid polymeric material according to any one of the first to third aspects, the process including producing a composite composition by adding, after the thermoplastic resin having an acid number of 1 to 200 mgKOH/g has been melted, the metal alkoxide compound and/or the partial condensate thereof to the molten resin, and thus incorporating the thermoplastic resin with the inorganic component.

A fifth aspect of the present invention is the process for production of a hybrid polymeric material according to any one of the first to fourth aspects, the process including: adding, after the thermoplastic resin having an acid number of 1 to 200 mgKOH/g has been melted, the metal alkoxide compound and/or the partial condensate thereof to the molten resin; and removing the thus produced by-product to the outside of the resin under normal pressures or reduced pressure.

A sixth aspect of the present invention is a process for production of a hybrid polymeric material, the process including a step of melt-kneading by using a kneading apparatus in the step of producing the hybrid polymeric material according to any one of the first to fifth aspects.

A seventh aspect of the present invention is the process for production of a hybrid polymeric material according to the sixth aspect, wherein the kneading apparatus is a continuous kneading apparatus.

An eighth aspect of the present invention is the process for production of a hybrid polymeric material according to the sixth or seventh aspect, wherein the kneading apparatus includes at least one selected from a single screw extruder, a twin screw extruder and a multiple screw extruder.

A ninth aspect of the present invention is the process for production of a hybrid polymeric material according to any one of the first to eighth aspects, wherein no organic solvent capable of dissolving the thermoplastic resin is used.

### Advantages of the Invention

According to the production process of the present invention, there can be produced in a one-step process and in a continuous manner an organic-inorganic hybrid polymeric material or polymeric materials including as a component thereof the organic-inorganic hybrid polymeric material without using a large amount of solvent, and without depending on the hydrolysis reaction due to a trace amount of water contained in the reaction system, by melt-kneading in a kneading machine a resin composition including a thermoplastic resin having a particular acid number and a metal alkoxide compound, with the molten resin as reaction place, without using any solvent, any catalyst and the like. Therefore, the production process can be extremely easily industrialized and applied to continuous mass production, leading to the industrialization of hybrid polymeric materials. The polymeric materials thus obtained can be processed with molding machines, and molded products made of organic-inorganic hybrid polymeric materials or polymeric materials including as a component thereof such an organic-inorganic hybrid polymeric material can be easily produced.

Additionally, the hybrid polymeric materials produced by such a production process have inorganic substances dispersed therein on nano-size level. When a polymeric material capable of transmitting visible light is used as a thermoplastic resin, dispersion of inorganic substances in the polymeric material in sufficiently smaller sizes relative to the wavelengths of visible light enables to maintain the visible light transmitting characteristics of the polymeric material even in a case where inorganic substances are dispersed in the polymeric material. This enables to apply hybrid polymeric materials as materials for use in various optical components.

Hybrid polymeric materials thus obtained can be used in various forms such as resin films, resin molded products, resin foams, painting materials and coating materials, in a broad range of applications including electronic, magnetic, catalytic, structural, optical, medical, automotive and architectural materials.

The polymeric materials obtained according to the present invention can be molded using common plastic molding machines such as currently widely used injection molding machines and extrusion molding machines, and hence result in easy molding of complicated shapes of the above-described high-performance and high-function polymeric materials.

### BRIEF DESCRIPTION OF THE DRAWINGS

FIG. 1 is a transmission electron microgram of a resin composition obtained in Example 1; and

FIG. 2 is a transmission electron microgram of a resin composition obtained in Example 4.

### BEST MODE FOR CARRYING OUT THE INVENTION

Hereinafter, the present invention will be described along with the embodiments of the present invention.

Examples of the thermoplastic resins used in the present invention may include:

polyolefins such as polyethylene and polypropylene; olefin/vinyl monomer copolymers such as olefin/maleimide copolymer; aromatic vinyl polymers such as polystyrene; aromatic vinyl/vinyl monomer copolymers such as styrene/acrylonitrile copolymer, styrene/methyl methacrylate copolymer and styrene/maleimide copolymer; poly(meth)acrylates such as polymethylmethacrylate;

polyphenylene ether; polycarbonates; polyvinyl chloride; polyethylene terephthalate; polyarylate; polyethersulfone; polyethylene naphthalate; polymethylpentene-1; alicyclic polyolefins (for example, ring-opening (co)polymers of cyclic olefins such as dicyclopentadiene polyolefin and norbornene polyolefin, the hydrogenated (co)polymers of these, and saturated copolymers of cyclic olefins and unsaturated double bond-containing compounds);

copolymers between alicylic (meth)acrylate such as tricyclodecanyl methacrylate and cyclohexyl methacrylate and (meth)acrylate such as methyl methacrylate; polysulfone; polyetherimide; amorphous polyamide; cellulose resins such as triacetyl cellulose; glutarimide resin; hydrogenated polymers obtained by hydrogenating the (co)polymers of cyclic olefins, cyclopentadiene and aromatic vinyl compounds; and others.

Also usable are rubbery polymer-reinforced resins obtained by copolymerizing the above-described polymers with various rubbery polymers such as butadiene, butyl acrylate and silicone rubbers by means of the processes for production of graft copolymers and the like.

Examples of the rubbery polymers include: polymers of conjugated double bond-containing monomers such as butadiene, isobutylene and isoprene; alkyl methacrylates and alkyl acrylates such as butyl acrylate and butyl methacrylate; silicone rubbers such as dimethylsiloxane and phenylmethylsiloxane; olefin elastomers such as ethylene/propylene copolymer and ethylene/propylene/diene copolymer; and others. Specific examples include polybutadiene rubber, styrene-butadiene rubber (SBR), acrylonitrile-butadiene rubber (NBR), butyl acrylate/butadiene rubber, ethylene/propylene rubber, acrylic rubber and silicone rubber.

A thermoplastic elastomer can also be used as a thermoplastic resin. As a thermoplastic elastomer, there can be generally used a block copolymer in which rigid parts and soft parts are copolymerized or crystalline resin parts and amorphous resin parts are copolymerized; in particular, by imparting an acid number to any of these parts, these can be used as preferable thermoplastic resins in the present invention. Examples of the block copolymer include a diblock copolymer, a triblock copolymer, a multiple block copolymer and a radial block copolymer, and any of these block copolymers may be used.

For example, in the case of a block copolymer between a vinyl monomer (compound) and a conjugated diene monomer (compound), an aromatic vinyl compound, vinyl cyanide, an alkyl (meth)acrylate or the like is used as the vinyl monomer (compound), and butadiene, isoprene or the like is used as the conjugated diene monomer (compound). Alternatively, there can also be used copolymers obtained by hydrogenation of the conjugated diene parts so as to partially or wholly saturate the double bond parts in the main chain.

Examples of the preferable thermoplastic elastomers include: polystyrene-polybutadiene-polystyrene copolymer; polystyrene-polyisoprene-polystyrene copolymer; polystyrene-poly(ethylene-butylene)-polystyrene copolymer; polystyrene-poly(ethylene-butylene)-polystyrene copolymer; polystyrene-polyisobutylene-polystyrene copolymer; and polystyrene-polyisobutylene copolymer.

Additionally, for example, in the case of a block copolymer composed of crystalline resin parts and amorphous resin parts, polyether ester elastomer, polyester ester elastomer, polyether amide elastomer or the like can be used. In general, these resins can be preferably used by adjusting the acid numbers of the polymer terminal groups.

Preferably, use of polymeric materials, among these, having characteristics of transmitting visible light enables to use hybrid materials in broad applications to optical components. Examples of the resins having preferable optical characteristics due to the capability of transmitting visible light include polymethylmethacrylate resins, polycarbonate resins, polystyrene resins, cycloolefin resins, cellulose resins, vinyl chloride resins, polysulfone resins, polyethersulfone resins, maleimide/olefin copolymer resins and glutarimide resins. These thermoplastic resins can also be used as mixtures of two or more thereof.

The acid number of the thermoplastic resin falls within a range from 1 to 200 mgKOH/g, preferably from 3 to 150 mgKOH/g, more preferably from 5 to 100 mgKOH/g and particularly preferably from 7 to 80 mgKOH/g. The acid number as referred to herein means the value measured according to JIS K0070. For the purpose of increasing the uniformity of a hybrid polymeric material, the acid number of the thermoplastic resin is required to be 1 or more. Additionally, when the acid number exceeds 200, the thermal stability of the thermoplastic resin is degraded, or the thermoplasticity of the resin is lost due to crosslinking reaction or the like as the case may be.

Even when a thermoplastic resin has an acid number of less than 1 mgKOH/g or 200 mgKOH/g or more, or has no acid number, if the thermoplastic resin can be mixed homogeneously with another thermoplastic resin different in acid number from the thermoplastic resin, mixing of these two thermoplastic resins enables the resultant acid number of the mixed thermoplastic resin as a whole to fall apparently within a range from 1 to 200 mgKOH/g, and consequently such a mixed thermoplastic resin can be used as the thermoplastic resin of the present invention.

For example, mixing a polyphenylene ether resin having an acid number of 0 mgKOH/g with a styrene/methacrylic acid copolymer having an acid number of 50 mgKOH/g in an appropriately adjusted mixing ratio enables the resultant acid number of the mixed thermoplastic resin as a whole to fall apparently within a range from 1 to 50 mgKOH/g, so as to meet a requirement of the present invention that the acid number fall within the range from 1 to 200 mgKOH/g. Polyphenylene ether resin and styrene/methacrylic acid copolymer are compatible with each other to a comparatively satisfactory degree, and hence a mixture of both can also be used in the present invention.

No particular constraint is imposed on the production process to make the acid number of the thermoplastic resin fall within the range from 1 to 200 mgKOH/g; various heretofore known production processes are applicable as such a production process. For example, examples of such a production process include a process for copolymerizing an acid group-containing monomer by using the acid group-containing monomer as part of the monomers, a process in which the acid number of the whole resin is controlled by controlling the number of the terminal acid groups, and a process in which an acid number is imparted to the thermoplastic resin by reacting, after resin polymerization, part of the reactive substituents in the resin.

For example, for a resin obtained by the addition polymerization of a monomer having an unsaturated bond, preferable is a process in which copolymerization is applied, at the time of production, to monomers containing an unsaturated carboxylic acid, an unsaturated sulfonic acid and derivatives of these acids such as acid anhydrides of these acids because such monomers are easily available and the resin is easily produced, and the obtained resin is excellent in the balance between the physical properties thereof. Examples of the monomers suitable for copolymerization include unsaturated carboxylic acid compounds such as acrylic acid, methacrylic acid, itaconic acid and maleic acid, and unsaturated carboxylic acid anhydrides such as maleic anhydride, itaconic anhydride and citraconic anhydride. These may be used alone or in combinations of two or more thereof.

It is to be noted that when an unsaturated carboxylic acid anhydride is used as it is, the acid number becomes zero as the case may be. Thus, the acid number can be appropriately adjusted by means of a process in which before polymerization of the monomer or after completion of polymerization, part of the unsaturated carboxylic acid anhydride is hydrolyzed to be converted into the unsaturated dicarboxylic acid, or further, one of the carboxylic groups of the unsaturated dicarboxylic acid is esterified to form an unsaturated dicarboxylic acid half ester, a process in which the resin is subjected to molding processing without sufficient drying while the resin still contains some amount of water absorbed therein, or other processes.

Additionally, for example, for a resin obtained by condensation of one or two or more monomers, a process in which a monomer containing a carboxylic acid and/or a sulfonic acid is copolymerized at the time of production is preferable because such monomers are easily available and the resin is easily produced, and the obtained resin is excellent in the balance between the physical properties thereof.

As another process, in the cases of a polyester obtained by condensation between an alcohol (and its derivatives) and a carboxylic acid (and its derivatives), a polycarbonate obtained by condensation between an alcohol (and its derivatives) and a carbonic acid (and its derivatives), and a polyamide obtained by condensation between an amine (and its derivatives) and an carboxylic acid (and its derivatives), the acid number of the obtained resin can be varied by controlling the molecular weight of the resin and the condition of the polymer terminal groups. Specifically, for example, polymerization of a resin, by controlling so as to decrease the molecular weight of the resin and increase the proportion of the carboxylic acid in the groups remaining at the resin terminals, enables to increase the acid number of the obtained resin.

Further, for the purpose of more uniformly disperse an inorganic substance in the thermoplastic resin, part or the whole of the thermoplastic resin may have functional groups, possessing reactivity, other than the acid groups. Examples of the production process which allows further introduction of functional groups possessing reactivity into the thermoplastic resin include a process in which monomers having functional groups are copolymerized, and a process in which a thermoplastic resin is modified by chemical reaction so as to be imparted with functional groups.

No particular constraint is imposed on the above-described thermoplastic resin having an acid number of 1 to 200 mgKOH/g. Specific examples of such a resin include: styrene/methacrylic acid copolymer, styrene/acrylic acid copolymer, a partial hydrolysate of styrene/maleic anhydride copolymer, methyl methacrylate/methacrylic acid copolymer, methyl methacrylate/acrylic acid copolymer, methyl methacrylate/acrylonitrile/methacrylic acid copolymer, methyl methacrylate/acrylonitrile/acrylic acid copolymer, cycloolefin/methacrylic acid copolymer, cycloolefin/acrylic acid copolymer, glutarimide/methacrylic acid copolymer, glutarimide/acrylic acid copolymer, carboxylic acid-terminated polyethylene terephthalate, carboxylic acid-terminated polycarbonate, a partial hydrolysate of maleimide/styrene/maleic anhydride copolymer, and a partial hydrolysate of maleimide/olefin/maleic anhydride copolymer.

Also preferably usable are rubbery polymer-reinforced resins obtained by copolymerizing the above-described polymers with various rubbery polymers such as butadiene, butyl acrylate and silicone rubbers. These can be used alone or in combinations of two or more thereof. Among these, because of easy availability and excellent thermal stability, preferably used are styrene/methacrylic acid copolymer, styrene/acrylic acid copolymer, a partial hydrolysate of styrene/malic anhydride copolymer, methyl methacrylate/methacrylic acid copolymer, methyl methacrylate/acrylic acid copolymer, and a partial hydrolysate of methyl methacrylate/maleic anhydride copolymer.

No particular constraint is imposed on the process for production of the thermoplastic resins used in the present invention; such thermoplastic resins are obtained by polymerizing monomer components by means of heretofore known polymerization processes such as emulsion polymerization, solution polymerization, suspension polymerization, mass polymerization and mass-suspension polymerization. In such polymerizations, no particular constraint is imposed on the mixing proportions of the monomer components; according to intended applications, individual components are mixed in appropriate proportions. These thermoplastic resins can be used each alone or in combinations of two or more thereof. When two or more resins are used in combination, such resins may be used by adding a compatibilizing agent or the like according to need. These thermoplastic resins may be selectively used so as to appropriately meet the intended applications.

Examples of the metal alkoxide compounds and/or the partial condensates thereof used in the present invention include alkoxides of various metals such as Si, Ti, Zr, Al, Ba, Ta, Ge, Ga, Cu, Sc, Bi, Sn, B, Fe, Ce, W, Pb and lanthanoids, and the partial condensates obtained by partial hydrolysis and polycondensation of these metal alkoxides.

Preferable among these are the compounds represented by the general formula (1) and the partial condensates obtained by partial hydrolysis and polycondensation of these metal alkoxides:

R¹ₐM general formula (1)

wherein R¹ represents an alkoxy group having 1 to 8 carbon atoms, M represents a metal element selected from Si, Ti, Zr, Al, Ba, Ta, Ge, Ga, Cu, Sc, Bi, Sn, B, Fe, Ce, W, Pb and lanthanoids, and a represents an integer of 1 to 6. It is to be noted that a is preferably 2 to 6.

Specific examples include: tetraalkoxysilanes such as tetramethoxysilane, tetraethoxysilane, tetraisopropoxysilane and tetrabutoxysilane; tetraalkoxytitaniums such as tetra-n-propoxytitanium, tetraisopropoxytitanium and tetrabutoxytitanium; tetraalkoxyzirconiums such as tetra-n-propoxyzirconium, tetraisopropoxyzirconium and tetrabutoxyzirconium; metal alkoxides such as dimethoxycopper, diethoxybarium, trimethoxyboron, triethoxygallium, tributoxyaluminum, tetraethoxygermanium, tetrabutoxylead, penta-n-propoxytantalum, hexaethoxytungsten, lanthanum alkoxides and tantalum alkoxides; and partial condensates of these compounds.

Other examples of the metal alkoxide compounds include the compounds represented by the general formula (2):

R²_{b}R¹_{c}M(R³_{d}X)ₑ general formula (2)

wherein R² represents a hydrogen atom, an alkyl group having 1 to 12, preferably 1 to 5 carbon atoms, or an aromatic hydrocarbon group having 6 to 12 carbon atoms; R¹ and M are the same as in the above-described general formula (1); R³ represents an alkylene group or an alkylidene group having 1 to 4, preferably 2 to 4 carbon atoms; X represents a functional group; b represents an integer of 0 to 5; c represents an integer of 1 to 5; d represents 0 or 1; and e represents an integer of 0 to 5. It is to be noted that the functional group X is preferably a functional group selected from an isocyanate group, an epoxy group, a carboxyl group, an acid halide group, an acid anhydride group, an amino group, a thiol group, a vinyl group, a methacryl group and halogen group.

Specific examples of the Si-containing compounds include: (alkyl)alkoxysilanes such as trimethoxysilane, triethoxysilane, tri-n-propoxysilane, dimethoxysilane, diethoxysilane, diisopropoxysilane, monomethoxysilane, monoethoxysilane, monobutoxysilane, methyldimethoxysilane, ethyldiethoxysilane, dimethylmethoxysilane, diisopropylisopropoxysilane, methyltrimethoxysilane, ethyltrimethoxysilane, methyltriethoxysilane, ethyltriethoxysilane, n-propyltri-n-propoxysilane, butyltributoxysilane, dimethyldimethoxysilane, dimethyldiethoxysilane, diethyldimethoxysilane, diethyldiethoxysilane, dimethylmethoxyethoxysilane, diethylmethoxyethoxysilane, methylethyldimethoxysilane, methylethyldiethoxysilane, diisopropyldiisopropoxysilane, dibutyldibutoxysilane, trimethylmethoxysilane, triethylethoxysilane, tri-n-propyl-n-propoxysilane, tributylbutoxysilane, phenyltriethoxysilane, diphenyldiethoxysilane, triphenylethoxysilane, phenyltrimethoxysilane, diphenyldimethoxysilane, triphenylmethoxysilane, phenyldiethoxymethoxysilane, phenylethoxydimethoxysilane, diphenylethoxymethoxysilane, diphenylmethylmethoxysilane, diphenylmethylethoxysilane, phenyldimethylmethoxysilane, phenyldimethylethoxysilane, phenylmethylethylmethoxysilane, phenylmethylethylethoxysilane, phenylmethyldimethoxysilane, phenylmethyldiethoxysilane, phenylethyldimethoxysilane, phenylethyldiethoxysilane, phenylmethylmethoxyethoxysilane and phenylethylmethoxyethoxysilane;

(alkyl)alkoxysilanes having an isocyanate group such as 3-isocyanatopropyltriethoxysilane, 2-isocyanatoethyltri-n-propoxysilane, 3-isocyanatopropylmethyldimethoxysilane, 2-isocyanatoethylethyldibutoxysilane, 3-isocyanatopropyldimethylisopropoxysilane, 2-isocyanatoethyldiethylbutoxysilane, di(3-isocyanatopropyl)diethoxysilane, di(3-isocyanatopropyl)methylethoxysilane and ethoxysilane triisocyanate;

(alkyl)alkoxysilanes having an epoxy group such as 3-glycidoxypropyltriethoxysilane, 3-glycidoxypropylmethyldimethoxysilane, 3-glycidoxypropyldimethylethoxysilane, 2-(3,4-epoxycyclohexyl)ethyltrimethoxysilane and 3,4-epoxybutyltrimethoxysilane;

(alkyl)alkoxysilanes having a carboxyl group such as carboxymethyltriethoxysilane, carboxymethylethyldiethoxysilane and carboxyethyldimethylmethoxysilane;

alkoxysilanes having an acid anhydride group such as 3-(triethoxysilyl)-2-methylpropylsuccinic anhydride;

alkoxysilanes having an acid halide group such as 2-(4-chlorosulfonylphenyl)ethyltriethoxysilane;

(alkyl)alkoxysilanes having an amino group such as 3-aminopropyltrimethoxysilane, 3-aminopropyltriethoxysilane, N-2-(aminoethyl)-3-aminopropyltriethoxysilane, N-2-(aminoethyl)-3-aminopropylmethyldimethoxysilane and N-phenyl-3-aminopropyltrimethoxysilane;

(alkyl)alkoxysilanes having a mercapto group such as 3-mercaptopropyltrimethoxysilane, 2-mercaptoethyltriethoxysilane and 3-mercaptopropylmethyldimethoxysilane;

(alkyl)alkoxysilanes having a vinyl group such as vinyltrimethoxysilane, vinyltriethoxysilane and vinylmethyldiethoxysilane;

(alkyl)alkoxysilanes having a methacryl group such as 3-methacryloxypropyltrimethoxysilane, 3-methacryloxypropyltriethoxysilane and 3-methacryloxypropylmethyldimethylsilane;

(alkyl)alkoxysilanes having a halogen group such as triethoxyfluorosilane, 3-chloropropyltrimethoxysilane, 3-bromopropyltriethoxysilane and 2-chloroethylmethyldimethoxysilane; and

partial condensates obtained from one or two or more of these compounds.

For the metal elements other than Si, such as Ti, Zr, Al, Ba, Ta, Ge, Ga, Cu, Sc, Bi, Sn, B, Fe, Ce, W, Pb and lanthanoids, the same example compounds as described above can be listed. Preferable examples of such compounds include: titanium alkoxides such as R²TiR¹₃; zirconium alkoxides such as R²ZrR¹₃; aluminum alkoxides such as R₂AlR¹₂; germanium alkoxides such as R²GeR¹₃; and partial condensates obtained from one or two or more of these compounds. It is to be noted that R¹ and R² are the same as in the above-described general formula (1) and (2).

These metal alkoxide compounds may be used alone or in combinations of two or more thereof. Metal alkoxide compounds including two or more metal elements in one molecule such as Mg[Al(OCH(CH₃)₂)₄]₂ and Ba[Zr₂(OC₂H₅)₉]₂, (C₃H₇O)₂Zr[Al(OC₃H₇)₄]₂ may also be used. Additionally, the alkoxy group may be an acetoxy group or an acetylacetoxy group.

The metal alkoxide compounds and/or the partial condensates thereof may be solid, liquid or gas, but are preferably solid or liquid from the viewpoint of easy handleability. In the case where such a compound is liquid, if the boiling point of the liquid is too low as compared to the melting temperature of the molten resin, the liquid evaporates or flies away before the reaction so as to inhibit uniform reaction as the case may be, and hence the boiling point of the compound is preferably controlled so as to be suitable for the reaction by subjecting the compound to an appropriate partial condensation.

Specifically, when tetraethoxysilane is used as an alkoxysilane, and is reacted in a molten resin having a temperature of approximately 250° C., the boiling point of tetraethoxysilane is considerably as lower as approximately 168° C. as compared to the temperature of the molten resin. Consequently, when tetraethoxysilane is added as it is into the molten resin, rapid vaporization occurs to increase the pressure or unfavorable reactions such as coagulation of inorganic substances in the resin are caused as the case may be. In order to avoid such inconveniences, it is preferable to use a compound obtained by partial condensation of tetraethoxysilane. Such partial condensates are widely available as commercial products under the name of silicate or the like, and can be obtained at low prices. Specifically, such condensates are preferably larger than a monomer and a decamer or smaller, and preferably dimer or larger and pentamer or smaller.

The polymeric material of the present invention is obtained by melt-kneading a thermoplastic resin and a metal alkoxide compound and/or a partial condensate thereof by using a kneading machine. By this processing, most of the metal alkoxide compound and/or the partial condensate thereof is converted into a metal oxide; however, by using a thermoplastic resin having an acid number falling within a range from 1 to 200 mgKOH/g, part of the metal alkoxide compound and/or the partial condensate thereof is reacted with the thermoplastic resin, and consequently the thermoplastic resin and the inorganic component (metal oxide) are bonded to each other or interact strongly (incorporate to form a composite) to produce an organic-inorganic hybrid polymeric material in which these components are finely dispersed.

There can also be obtained a polymeric material containing as a component thereof the organic-inorganic hybrid polymeric material by controlling the composition ratio between the thermoplastic resin and the metal alkoxide compound and/or the partial condensate thereof, the number of the above-described bonds in the thermoplastic resin, and the kneading conditions, and by using in combination a thermoplastic resin having no above-described bonds. In the case of such a polymeric material, the contained organic-inorganic hybrid polymeric material works as an interface modifier, and imparts affinity between the thermoplastic resin and the metal oxide generally incompatible with each other. Consequently, the polymeric material obtained in the present invention can be expected to have excellent characteristics and novel functions.

The composition ratio between the thermoplastic resin and the metal alkoxide compound and/or the partial condensate thereof can be set at an optional ratio according to the intended characteristics and functions. However, in view of the operability at the time of processing and the characteristics of the obtained material, the weight ratio therebetween falls preferably within a range from 10:90 to 99.999:0.001, more preferably from 30:70 to 99.99:0.01, furthermore preferably from 50:50 to 99.9:0.1, and most preferably from 90:10 to 99.9:0.1. When the used amount of the thermoplastic resin is too small, the kneading processing becomes difficult.

Additionally, not all the metal alkoxide compound and/or the partial condensate thereof is reacted with the thermoplastic resin, and some fraction of the metal alkoxide compound and/or the partial condensate thereof may be lost by the heat at the time of kneading depending on the types of the metal alkoxide compound and/or the partial condensate thereof. Thus, when the used amount of the metal alkoxide compound and/or the partial condensate thereof is too small, the produced amount of the organic-inorganic hybrid polymeric material is decreased, leading to a possibility that the characteristics of the material are not improved.

For the process for production of a polymeric material in the present invention, it is preferable to use a process in which a resin composition containing a thermoplastic resin and a metal alkoxide compound and/or a partial condensate thereof is melt-kneaded with a kneading machine, and the metal alkoxide compound and/or the partial condensate thereof is reacted in the thermoplastic resin. In this way, there is effected an interaction between the thermoplastic resin and a metal oxide and/or an inorganic component generally incompatible with each other, and thus a polymeric material in which these components are uniformly and finely dispersed in the thermoplastic resin can be produced simply and easily with high productivity and low cost. Additionally, the polymeric material thus obtained can be molded, and thus molded products having complicated shapes can also be produced. The molding may be carried out directly from the molten state after the kneading, or may be carried out after the resin discharged from the kneading machine has been converted into appropriate shapes such as pellets.

When the thermoplastic resin and the metal alkoxide compound and/or the partial condensate thereof are kneaded, various common kneading machines can be used. Examples of such a kneading machine include a single screw extruder, a twin screw extruder and multiple screw extruders such as a quadruple screw extruder and a sixteen screw extruder, a roll, a banbury mixer and kneaders. Preferable among these is a continuous kneading machine because such a continuous kneading machine enables continuous production and continuous performance of a series of operations including feeding of materials, reaction, removal of by-products, and takeoff and molding of the produced material.

Particularly preferable among these are kneading apparatuses having high shear efficiency; one or more selected from a single screw extruder, a twin screw extruder and a multiple screw extruder are particularly preferable. The thermoplastic resin and the metal alkoxide compound and/or the partial condensate thereof may be fed together simultaneously in a kneading apparatus to be melt-kneaded. Alternatively, the thermoplastic resin and the metal alkoxide compound and/or the partial condensate thereof may be melt-kneaded as follows: to the thermoplastic resin having been beforehand converted into molten state, the liquid metal alkoxide compound and/or the partial condensate thereof is added as a single substance, or as a dispersion with a dispersion medium such as a solvent which is subsequently removed thereafter. Preferably, a liquid raw material is fed into the melt-kneading apparatus in a midstream addition manner in the course of production with a liquid feed pump or the like.

Preferable examples of the process for production of such a composition as described above include a process in which the molten thermoplastic resin composition is placed under an ambient pressure reduced to be equal to or lower than atmospheric pressures. Such a reduced pressure enables appropriate reduced-pressure removal of the by-products such as alcohol produced from the reaction of the metal alkoxide compound and/or the partial condensate thereof, and hence the thermoplastic resin composition is prevented from contamination by the by-products, and moreover, the removal of the by-products can promote the reaction.

No particular constraint is imposed on the production apparatus to be used for such a production process as described above; however, it is preferable to use a melt-kneading apparatus having a pressure reduction mechanism. For the purpose of preventing the produced inorganic substance from coagulation in the resin, the melt-kneading apparatus to be most preferably used is an extruder having two or more intermeshing screws. When an extruder having two or more intermeshing screws is used, it is preferable to have a resin-retaining structure such as a kneading disk or a reverse screw structure at a position between the raw material feed opening and the pressure reduction opening in the screw section. Herewith, the resin composition can be continuously produced while the region around the pressure reduction opening is being maintained in a reduced pressure condition.

The kneading conditions such as the temperature, speed and pressure at the time of kneading and the molding conditions are appropriately determined according to the used thermoplastic resin; no particular constraint is imposed on the kneading conditions as long as the kneading conditions are such that the thermoplastic resin is melted and sufficiently kneaded with the other raw materials. When a single run of processing results in insufficient kneading, the discharged kneaded material may be subjected to two or more runs of processing by using the same kneading machine, or two or more kneading machines and/or kneading machines different in type.

Specifically, the polymeric material and the molded products of the present invention can be produced as follows. A thermoplastic resin having an acid number falling in a range from 1 to 200 mgKOH/g is fed in a kneading machine from the feeder thereof and is subjected to heat treatment to be converted into a molten state. Then, a metal alkoxide compound and/or a partial condensate thereof is fed in the kneading machine from a liquid addition unit or the like, and is reacted in the thermoplastic resin by performing melt-kneading.

In this case, by controlling the speed of the addition of the metal alkoxide compound and/or the partial condensate thereof, the content ratio of the organic-inorganic hybrid polymeric material in the polymeric material can be adjusted. Thereafter, the by-products such as alcohol are removed under reduced pressure from the pressure reduction opening of the kneading machine, and the thus obtained reaction product is discharged from the kneading machine. At the same time as the discharge, the reaction product may be directly molded into film, sheet, rod, pipe or the like. Alternatively, after the resin discharged from the kneading machine has been converted into appropriate shapes such as pellets, the molding into desired shapes may be carried out by using an injection molding machine or the like.

In the kneading step in the present invention, a small amount of water and a small amount of a catalyst may be added, for the purpose of further enhancing the reactivity of the metal alkoxide compound and/or the partial condensate thereof in the thermoplastic resin. The amount of water is not particularly limited, and may be appropriately set according to the physical properties of the used raw materials.

In all the steps in the present invention, metals such as Si, Ti, Zr, Al, Ba, Ta, Ge, Ga, Cu, Sc, Bi, Sn, B, Fe, Ce, W, Pb and lanthanoids, and oxides, complexes and inorganic salts of these metals may be included therewith, for the purpose of improving or newly imparting the functions such as strength, hardness, weatherability, chemical resistance, flame retardancy and antistatic property.

In the polymeric materials produced on the basis of the production process of the present invention, the thermoplastic resin is satisfactorily imparted with the properties possessed by inorganic materials, namely, mechanical strength, heat resistance, weatherability, surface hardness, rigidity, water resistance, chemical resistance, staining resistance and flame retardancy.

The thermoplastic resin compositions according to the present invention may be converted into reinforced materials by being combined with reinforcing fillers within a range not impairing the characteristics of the present invention. In other words, addition of reinforcing fillers enables to further improve the heat resistance, mechanical strength and the like. No particular constraint is imposed on such reinforcing fillers; examples of such fillers include: fibrous fillers such as glass fiber, carbon fiber and potassium titanate fiber; glass bead and glass flake; silicate compounds such as talc, mica, kaolin, wollastonite, smectite and diatomaceous earth; calcium carbonate, calcium sulfate and barium sulfate. Preferable among these are the silicate compounds and the fibrous fillers.

For the purpose of further enhancing the performance of the thermoplastic resin compositions of the present invention, it is preferable to use the following agents alone or in combinations two or more thereof: antioxidants such as phenolic antioxidants and thioether antioxidants; heat stabilizers such as phosphorus stabilizers; and others. Further, according to need, the following usually well known additives may also be used alone or in combinations of two or more thereof: a lubricant, a mold release agent, a plasticizer, a flame retardant, a flame retardant aid, an antidripping agent, an ultraviolet absorber, a light stabilizer, a pigment, a dye, an antistatic agent, a conductivity imparting agent, a dispersant, a compatibilizing agent, an antibacterial agent and the like.

No particular constraint is imposed on the process for molding the thermoplastic resin compositions produced in the present invention; there can be used generally used molding processes such as film molding, injection molding, blow molding, extrusion molding, vacuum molding, press molding, calender molding and foam molding. Additionally, the thermoplastic resin compositions of the present invention can be suitably used in various applications.

### EXAMPLES

Hereinafter, Examples are presented to further clarify what is characteristic of the present invention.

Observation of the Inorganic Substance Dispersibility in the Resin Composition:

An ultrathin section for TEM observation was prepared from each of the obtained hybrid polymeric materials by using an ultramicrotome (Ultracut UCT; manufactured by Leica Inc.), and then the dispersion state of the ultrafine particles was photographed at several locations at a magnification of 10,000 to 400,000 by using a transmission electron microscope (TEM) (JEOL; JEM-1200EX).

Improvement Rate of the Elastic Modulus of Resin at the Glass Transition Point of Resin as a Single Substance:

Viscoelastic properties of each of the polymeric material films at a frequency of 1 Hz were measured with a viscoelasticity spectrometer EXSTAR6000DMS manufactured by SII Nanotechnology Inc., by increasing the temperature of each film from room temperature at a temperature increase rate of 2° C./min in the tensile mode. The same measurements were carried out for each thermoplastic resin prior to hybridization as a single substance, the glass transition temperature of the resin as a single substance was measured from the tan δ value, and thereafter, the same measurement was carried out for the obtained polymeric material. Thus, the storage elastic modulus thereof at the glass transition point of the resin as a single substance was compared with that of the resin as a single substance; in this way, the elastic modulus improvement rate at the glass transition point of the resin as a single substance was measured.

### Production Example 1

In a reaction vessel equipped with a stirrer and a reflux condenser, under a nitrogen gas flow, 250 parts of ion-exchanged water, 0.4 part of sodium formaldehydesulfoxylate, 0.0025 part of ferrous sulfate, 0.01 part of disodium ethylenediaminetetraacetate and 2 parts of sodium dioctylsulfosuccinate were charged. The reaction mixture thus obtained was heated to 60° C. under stirring. Thereafter, 72 parts of styrene, 20 parts of acrylonitrile and 8 parts of methacrylic acid were continuously added dropwise over a period of 6 hours to the reaction mixture together with cumene hydroperoxide as initiator and t-dodecylmercaptan as a polymerization regulator. After completion of the dropwise addition, the reaction mixture was further continuously stirred at 60° C. for 1 hour to complete the polymerization. Then, the reaction mixture was coagulated with an aqueous solution of calcium chloride, and thereafter washed with water, dehydrated and dried to yield a methacrylic acid/styrene/acrylonitrile copolymer (A).

### Production Example 2

In a reaction vessel equipped with a stirrer and a reflux condenser, under a nitrogen gas flow, 250 parts of ion-exchanged water, 0.4 part of sodium formaldehydesulfoxylate, 0.0025 part of ferrous sulfate, 0.01 part of disodium ethylenediaminetetraacetate and 2 parts of sodium dioctylsulfosuccinate were charged. The reaction mixture thus obtained was heated to 60° C. under stirring. Thereafter, 75 parts of α-methylstyrene, 20 parts of acrylonitrile and 5 parts of methacrylic acid were continuously added dropwise over a period of 6 hours to the reaction mixture together with cumene hydroperoxide as initiator and t-dodecylmercaptan as a polymerization regulator.

After completion of the dropwise addition, the reaction mixture was further continuously stirred at 60° C. for 1 hour to complete the polymerization to yield a carboxylic acid-containing copolymer (B). On the other hand, in another reaction vessel equipped with a stirrer and a reflux condenser, under a nitrogen gas flow, 250 parts of ion-exchanged water, 0.5 part of potassium persulfate, 100 parts of butadiene, 0.3 part of t-dodecylmercaptan and 3 parts of disproportionated sodium rosinate were charged. Polymerization was carried out at a polymerization temperature of 60° C., the polymerization was terminated at a polymerization conversion rate of 80% for butadiene, and the unreacted butadiene was removed to yield a latex of polybutadiene.

The latex was adjusted in concentration by adding ion-exchanged water thereto so that the water content was 250 parts and the polybutadiene content was 70 parts. Then, under a nitrogen gas flow, the latex was added with 0.4 part of sodium formaldehydesulfoxylate, 0.0025 part of ferrous sulfate and 0.01 part of disodium ethylenediaminetetraacetate, and was heated to 60° C. under stirring. Thereafter, 20 parts of methyl methacrylate and 10 parts of styrene were continuously added dropwise over a period of 5 hours to the reaction mixture together with cumene hydroperoxide as initiator and t-dodecylmercaptan as a polymerization regulator.

After completion of the dropwise addition, the reaction mixture was further continuously stirred at 60° C. for 1 hour to complete the polymerization to yield a rubbery polymer-containing graft copolymer (C). A latex of the carboxylic acid-containing copolymer (B) and a latex of the rubbery polymer-containing graft copolymer (C) were homogeneously mixed together in a ratio of 2:1. Then, the mixture was added with a phenolic antioxidant and coagulated with an aqueous solution of calcium chloride, washed with water, dehydrated and dried to yield a rubber-containing aromatic vinyl resin (D) containing the carboxylic acid-containing copolymer (B) and the rubbery polymer-containing graft copolymer (C).

In Examples, as the thermoplastic resins, the following were used.

Thermoplastic Resin 1:

A styrene/methacrylic acid copolymer G9001 (manufactured by PS Japan Corp.) (Acid number: 53).

Thermoplastic Resin 2:

The styrene/acrylonitrile/methacrylic acid copolymer produced in Production Example 1 (Acid number: 48).

Thermoplastic Resin 3:

The aromatic vinyl copolymer containing a rubbery polymer-containing graft copolymer, produced in Production Example 2 (Acid number: 18).

Thermoplastic Resin 4:

A commercially available, general-purpose polystyrene resin G9305 (manufactured by PS Japan Corp) (Acid number: 0).

Thermoplastic Resin 5:

A commercially available polycarbonate resin containing carbonate bonds in the resin, Taflon A2500 (manufactured by Idemitsu Sekiyu Kagaku Co., Ltd.) subjected to 5-hour or more dehumidification to dryness at 120° C. (Acid number 0).

Additionally, in Examples, as the metal alkoxide compound and/or the partial condensate thereof, the following were used.

Alkoxide 1: A partial condensate of tetraethoxysilane, Ethyl Silicate 40 (manufactured by Tama Chemicals Co., Ltd.).

Alkoxide 2: Phenyltriethoxysilane, LS-4480 (manufactured by Shin-Etsu Chemical Co., Ltd.).

### Example 1

In this case, 600 g of the thermoplastic resin 1 and 0.6 g of a phenolic stabilizer Adekastab AO-60 (manufactured by Asahi Denka Co., Ltd.) were separately weighed out and subjected to dry blending. The thermoplastic resin 1 and the stabilizer were fed to the rear part of the screw in a 15-mm intermeshing co-rotating twin screw extruder KZW15-45 (manufactured by Technovel Corp.; L/D=45) equipped with two pressure reduction vent openings at midway positions in the screw section, under the melt-kneading conditions of the head temperature set at 230° C., the screw rotation speed set at 300 rpm and the discharge rate set at 300 g/hr. The melt-kneading was carried out by further feeding 0.74 g of the alkoxide 1 and 0.56 g of the alkoxide 2 from the liquid addition opening at a midway position in the screw section with a liquid addition pump.

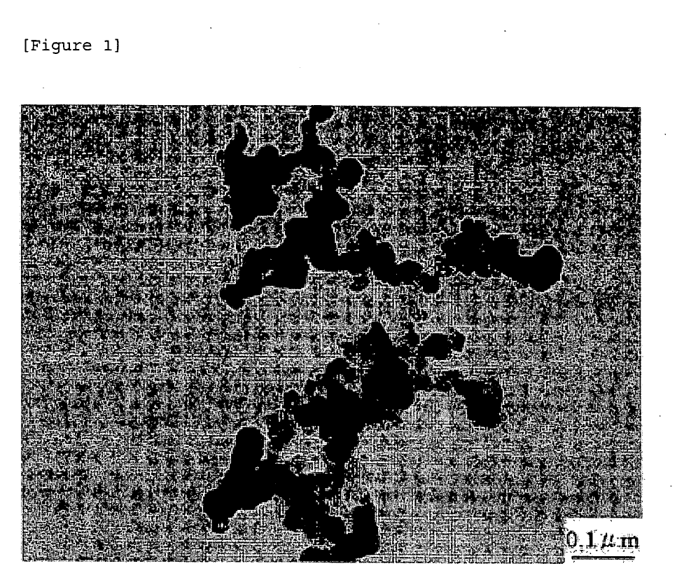

A 150-mm wide T-shaped die was further placed at the head of the melt-kneading apparatus, and a film-shaped sample extruded from the die was wound up with a roll controlled in temperature at 95° C. at a rate of 100 m/hr to yield a sample of a transparent resin film in which silica ultrafine particles were dispersed in the thermoplastic resin. FIG. 1 shows a TEM photogram of the hybrid polymeric material in which the thermoplastic resin and the inorganic component were incorporated with each other to form a composite. The elastic modulus improvement rate, at the glass transition point of the resin as a single substance, was 580%. The glass transition temperature of the resin was also increased by approximately 3° C.

### Example 2

A hybrid polymeric material in a form of a composite was obtained by melt-kneading in the same manner as in Example 1 except that the thermoplastic resin 2 was used in an amount of 600 g in place of the thermoplastic resin 1. The elastic modulus improvement rate, at the glass transition point of the resin as a single substance, was 510%.

### Example 3

A hybrid polymeric material in a form of a composite was obtained by melt-kneading in the same manner as in Example 1 except that the thermoplastic resin 3 was used in an amount of 600 g in place of the thermoplastic resin 1. The elastic modulus improvement rate, at the glass transition point of the resin as a single substance, was 525%.

### Example 4

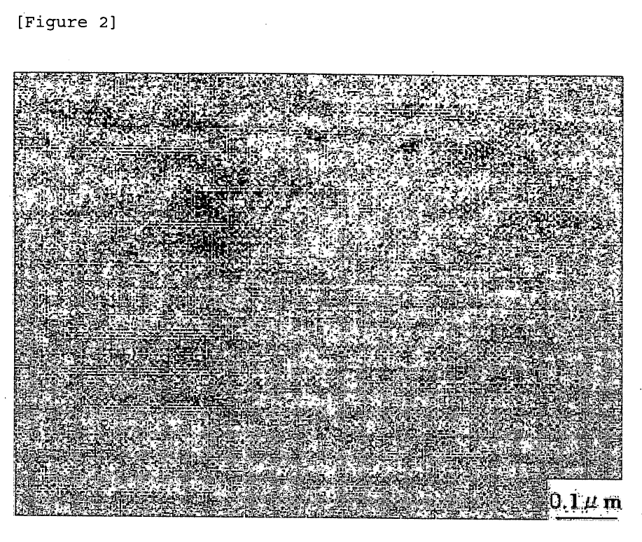

A hybrid polymeric material in a form of a composite was obtained by melt-kneading in the same manner as in Example 1 except that the alkoxide 2 was used in an amount of 1.12 g as the metal alkoxide compound and/or the partial condensate thereof. FIG. 2 shows a TEM photogram of the thus obtained hybrid polymeric material in a form of a composite. As can be seen from the TEM observation, the inorganic substance is incorporated with the resin to form a composite. The elastic modulus improvement rate, at the glass transition point of the resin as a single substance, was 530%. The glass transition temperature of the resin was also increased by approximately 3° C.

### Comparative Example 1

Melt kneading was carried out in the same manner as in Example 1 except that the thermoplastic resin 4 was used in an amount of 600 g in place of the thermoplastic resin 1. A 150-mm wide T-shaped die was further placed at the head of the melt-kneading apparatus, and a film-shaped sample extruded from the die was wound up with a roll controlled in temperature at 85° C. at a rate of 100 m/hr to yield a polymer film. The thus obtained film had a nonuniform appearance having a large number of blobs of a few millimeters in size, and was a sticky feeling film in which the metal alkoxide compound and/or the partial condensate thereof added in the course of the processing was mixed as unreacted in the film, and was far away from practical use. The elastic modulus improvement rate, at the glass transition point of the resin as a single substance, was hardly measurable.

### Comparative Example 2

In this case, 36 g of a commercially available silica nanoparticle, Aerosil 200 (manufactured by Nippon Aerosil Co., Ltd.; number average particle size: 12 nm), 600 g of the thermoplastic resin 1, and 0.6 g of a phenolic stabilizer Adekastab AO-60 (manufactured by Asahi Denka Co., Ltd.) were respectively subjected to dry blending. Thereafter, the obtained mixture was melt-kneaded in a 15-mm intermeshing co-rotating twin screw extruder KZW15-45 (manufactured by Technovel Corp.; L/D=45) equipped with two pressure reduction vent openings at midway positions in the screw section, under the melt-kneading conditions of the head temperature set at 230° C., the screw rotation speed set at 300 rpm and the discharge rate set at 300 g/hr.

A 150-mm wide T-shaped die was further placed at the head of the melt-kneading apparatus, and a film-shaped sample extruded from the die was wound up with a roll controlled in temperature at 95° C. at a rate of 100 m/hr to yield a polymer composite material. Although the addition amount of the inorganic substance was drastically increased by a factor of 60 as compared to Example 1, the elastic modulus improvement rate, at the glass transition point of the resin as a single substance, was 90% to give a result drastically inferior to that in Example 1. The glass transition temperature of the resin was scarcely changed from that of the original thermoplastic resin 1 as a single substance, with the difference therebetween less than 1° C.

### Comparative Example 3

Melt kneading was carried out in the same manner as in Example 1 except that the thermoplastic resin 5 was used in an amount of 600 g in place of the thermoplastic resin 1 and the head temperature of the twin screw extruder was set at 280° C. A 150-mm wide T-shaped die was further placed at the head of the melt-kneading apparatus, and a film-shaped sample extruded from the die was wound up with a roll controlled in temperature at 120° C. at a rate of 100 m/hr to yield a polymer film. The thus obtained film had a nonuniform appearance similarly to the case of Comparative Example 1; the obtained film was a sticky feeling film in which the metal alkoxide compound and/or the partial condensate thereof added in the course of the processing was mixed as unreacted, and was far away from practical use. The elastic modulus improvement rate, at the glass transition point of the resin as a single substance, was hardly measurable.

### INDUSTRIAL APPLICABILITY

According to the present invention, a hybrid polymeric material in which an organic polymer and an inorganic material are homogenized at a molecular level can be produced, without using any organic solvent or the like, continuously on a massive scale by means of a simple and efficient process. Consequently, it is enabled to massively produce, on an industrial scale and also with extreme industrial usefulness, hybrid polymeric materials having hitherto scarcely been used because the production and processing thereof were difficult and hence high in cost although such hybrid polymeric materials have been expected to be applicable to various fields owing to high performances thereof.

1. A process for production of a hybrid polymeric material, the process comprising producing a composite composition in which a thermoplastic resin having an acid number of 1 to 200 mgKOH/g is incorporated with an inorganic component formed from a metal alkoxide compound and/or a partial condensate thereof by melting the thermoplastic resin.

2. The process for production of a hybrid polymeric material according to claim 1, the process comprising producing a composite composition in which a thermoplastic resin having an acid number of 1 to 200 mgKOH/g is incorporated with an inorganic component by bringing the thermoplastic resin in the molten state thereof into contact with the metal alkoxide compound and/or the partial condensate thereof.

3. The process for production of a hybrid polymeric material according to claim 1, wherein the metal component in the metal alkoxide compound and/or the partial condensate thereof comprises at least one of Si, Ti, Zr, Al, Ba, Ta, Ge, Ga, Cu, Sc, Bi, Sn, B, Fe, Ce, W, Pb and lanthanoids.

4. The process for production of a hybrid polymeric material according to claim 1, the process comprising producing a composite composition by adding, after the thermoplastic resin having an acid number of 1 to 200 mgKOH/g has been melted, the metal alkoxide compound and/or the partial condensate thereof to the molten resin, and thus incorporating the thermoplastic resin with the inorganic component.

5. The process for production of a hybrid polymeric material according to claim 1, the process comprising:
adding, after the thermoplastic resin having an acid number of 1 to 200 mgKOH/g has been melted, the metal alkoxide compound and/or the partial condensate thereof to the molten resin; and
removing the thus produced by-product to the outside of the resin under normal pressures or reduced pressure.

6. A process for production of a hybrid polymeric material, the process comprising a step of melt-kneading by using a kneading apparatus in the step of producing the hybrid polymeric material according to claim 1.

7. The process for production of a hybrid polymeric material according to claim 6, wherein the kneading apparatus is a continuous kneading apparatus.

8. The process for production of a hybrid polymeric material according to claim 6, wherein the kneading apparatus includes at least one selected from a single screw extruder, a twin screw extruder and a multiple screw extruder.

9. The process for production of a hybrid polymeric material according to claim 1, wherein no organic solvent capable of dissolving the thermoplastic resin is used.
